(19) United States
(12) Patent Application Publication
(10) Pub. No.: US 2004/0015809 A1
(43) Pub. Date: Jan. 22, 2004

(54) Code generation for integrating devices into a middleware framework

(76) Inventor: Doreen Yining Cheng, Los Altos, CA (US)

Correspondence Address: Corporate Patent Counsel, U.S. Philips Corporation, 580 White Plains Road, Tarrytown, NY, 10591, US

(21) Appl. No.: 09/861,418

(22) Filed: May 18, 2001

(51) Int. Cl. G06F 9/44

(52) U.S. Cl. 717/100; 717/101

(57) ABSTRACT

A middleware code generation system generates program code for integrating a device into a network. A variety of tools and a user interface are provided to create databases that contain the information required to generate the middleware integration code. The code generation system is configured to facilitate user modifications to the generated code, and particularly modifications to the code for error handling. In a preferred embodiment, the code generation system also generates a sample test application that serves to illustrate how to use the generated integration code in an application.

### BACKGROUND OF THE INVENTION

1. Field of the Invention

This invention relates to the field of electronic networks and consumer electronics, and in particular to the generation of program code for integrating devices into a middleware framework, such as a middleware framework for a home automation network.

2. Description of Related Art

As digital electronic devices, such as DTV, D-VHS, phone, audio player, still and video cameras, and so on, become more and more popular, consortiums have been formed to define middleware to ease the control and management of these devices, typically via a networked environment. HAVi, Jini, and UPnP are a few examples of such effort. As commonly understood “middleware” is a layer of software between the network and the applications that provide services such as identification, authentication, security, control, and so on, related to devices on the network.

Writing software to integrate a device into a middleware framework is a non-trivial task. In addition to the software for its primary functions, a digital device must also include software that performs functions required by the middleware and makes the device capability accessible and controllable by other devices and/or software through the network.

The existence of multiple middleware exacerbates the problem. If the vendor of the device is expected to provide a template for integrating the device into such middleware, the vendor would need to provide a variety of templates, as well as appropriate schemes for assuring that the proper template is used. In like manner, if the user's environment includes multiple networks, each with different middleware, the user must learn the programming language and middleware requirements of each of these networks.

### BRIEF SUMMARY OF THE INVENTION

It is an object of this invention to provide a method and system that facilitates the generation of the program code required to interface a device to a network. It is a further object of this invention to provide the code required to facilitate the control of a device on a network.

These objects and others are achieved by providing a middleware code generation system that generates program code for integrating a device into a network. A variety of tools and a user interface are provided that enable users to create databases that contain the information required to generate the middleware integration code. In a preferred embodiment, the code generation system is configured to facilitate user modifications to the generated code, and particularly modifications to the code for error handling. In a preferred embodiment, the code generation system also generates a sample test application that serves to illustrate how to use the generated integration code in an application. In addition, in a preferred embodiment, the code generation system generates compilation facilities such as Makefiles.

### BRIEF DESCRIPTION OF THE DRAWINGS

The invention is explained in further detail, and by way of example, with reference to the accompanying drawings wherein:

FIG. 1 illustrates an example block diagram of a middleware code generation system in accordance with this invention.

FIG. 2 illustrates an example block diagram of a code generation engine in accordance with this invention.

FIG. 3 illustrates an example block diagram of the information kept in a Function Control Module (FCM) component of the HAVi specification database, for use by the code generation system to generate FCM code to facilitate integrating a device to the HAVi middleware in accordance with this invention.

FIG. 4 illustrates an example block diagram of the information kept in a Data Structure component of the FCM component for use by a middleware code generation system in accordance with this invention.

FIG. 5 illustrates an example block diagram of the information kept in a Service Application Program Interface (API) component of the FCM component for use by a middleware code generation system in accordance with this invention.

FIG. 6 illustrates an example block diagram of the information kept in an Event component of the FCM component for use by a middleware code generation system in accordance with this invention.

FIG. 7 illustrates an example block diagram of the information kept in a Notification Attributes component of the FCM component for use by a middleware code generation system in accordance with this invention.

FIG. 8 illustrates an example block diagram of the information kept in a Private Link component of the Private Link Database for use by a middleware code generation system in accordance with this invention.

FIG. 9 illustrates an example block diagram of the information kept in a Link State Response component of a particular link type for use by a middleware code generation system in accordance with this invention.

FIG. 10 illustrates an example block diagram of the installation of code that is generated in a middleware code generation system in accordance with this invention.

Throughout the drawings, the same reference numerals indicate similar or corresponding features or functions.

### DETAILED DESCRIPTION OF THE INVENTION

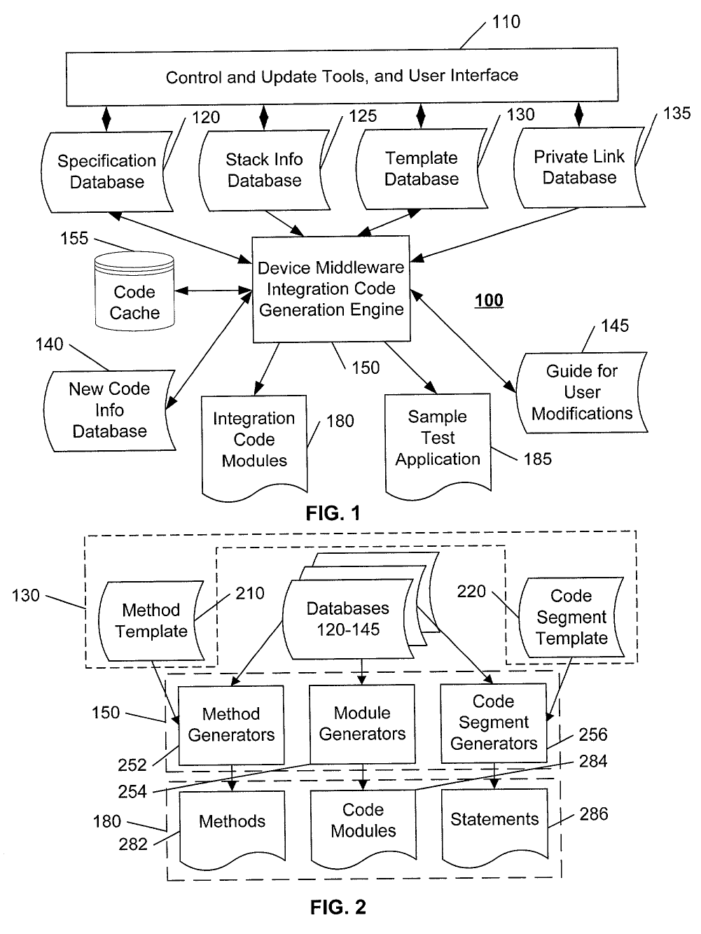

FIG. 1 illustrates an example block diagram of a middleware code generation system 100 in accordance with this invention. The code generation system 100 comprises software tools 110, databases 120,125, 130,135, and a code generation engine 150. It is configured to enable automatic generation of software that integrates an electronic device into a middleware framework, such as a HAVi network. The software tools 110 provide a user interface that is used to provide the information 120-135 required by a code generation engine 150 to generate modules of integration code 180. The interface device 110 is also used to control the code generation process and to modify the generated code. The information 120-135 is illustrated as being organized as a combination of databases, wherein the term database is used to mean a logical data storage that contains information that is structured for code generation purposes. Although a true database can be used, in-core data structures and files may also be used.

In operation, a user of the system 100 knows about the characteristics and functionality of the device for which the code 180 isgenerated. In a typical code generation process, a user uses the software tools 110 to indicate the type of the device for which the code 180 is generated and the type of the private link¹ used to communicate with the device. For example, the user may note that the device is a VCR and that it contains a tuner, a tape recorder, and a tape player, as sub-units. The software tools 110 also allow the user to specify device features that are not yet covered by the middleware specification. In a preferred embodiment, the code generation system 150 generates the integration code modules 180 and a sample test application 185 for the device. The integration code 180 is provided to integrate a device into the middleware environment, and the test application 185 is provided to show how to use the integration code 180 in an application. The code generation engine 150 also generates a list of pointers, such as line numbers and file names, that provides an index to the portions of the generated code 180 where user modifications are recommended. The modification information is preferably provided in the form of a guide for user modifications 145, and these modifications are preferably defined such that the user does not require knowledge of the middleware. Typically, the suggested modifications 145 involve error-handling code. Comments are also in place in the code 180 to show the user why and how to modify the code 180. In a preferred embodiment, the software tools 110 also provides an interface to show the user the code segments in the code 180, one by one, and guides the user through the modification process. In a preferred embodiment, the code generator system 100 is also configured to generate compilation utilities such as Makefiles for the generated code. 1. As used herein, private link indicates the type of network and/or the protocols used to connect the device to the middleware if the type differs from the types known to the middleware.

The code generation process is primarily driven by the middleware specification. For example, the code generation for a HAVi Video Cassette Recorder (VCR) Function Control Module (FCM) isdriven by the HAVi VCR FCM specification. To accomplish this, the relevant information in the middleware specification is converted into a form (120) that can easily be used for code generation. The software tools 110 also assist the conversion of a specification to a specification database. Using these tools 110, the conversion is done through two steps.

Step 1: user guided automatic conversion. The software tools 110 include parsers and formatters that automatically convert the information in the specification into a specification database 120 based on the syntax of the specification text. This step generates the major portion of the information needed. The tools allow the user to choose only the parts of the specification that are relevant to their business. For example, if a company produces only VCRs and Cameras, only the information related to the parts of the specification relevant to VCRs and Cameras is used.

Step 2: user augmentation and specification. If the semantic information is formally defined in the specification, such as, for example, in case of UPnP, the information is extracted and kept in the specification database 120. If, however, the semantic information is not formally expressed in the specification, as in the case of HAVi, the software tools 110 allow a user to augment the specification database 120 based on the semantics defined by the specification. The semantic information typically comes from the knowledge about the device and the understanding of the specification for the device. For example, a play command changes the transport mode of a VCR to the value play, and this change triggers an event. A user can use tools to specify features that are not covered by the middleware specification and the private link information. For example, if a camera has GPS capability, this capability needs to be added in the specification database for proper generation of code to export the capability to the middleware. In case of HAVi, this capability can be modeled as an FCM of the camera device. A user can also use tools to modify templates 130 to influence future code construction.

In the description below, the term modules and methods (functions) follow standard definition defined in programming languages. As is known in the art, different programming languages use different terminology for groups of operations: object-oriented languages, such as Java use “method”; procedural languages, such as C, Pascal, and Fortran use “procedure”, “subroutine”, and “function”; and so on. For ease of reference, the term “methods (functions)” is used hereinafter to distinguish this programming interpretation of “methods”. The term code segment is used in this application to represent a sequence of one or more consecutive program statements.

The architecture and the coding style of the target code 180 (the code to be generated) are designed to simplify code generation algorithms. The target code modules 180 are designed so that they can be categorized into a small number of groups and the structure of the modules in a group follow a similar pattern. Parameters such as the name of the vendor, the type and model of the device can be used to differentiate desired code modules from irrelevant modules. For example, a user can use “VCR model xyz made by Philips” to specify the code modules to be generated. Parameters such as the type of code (e.g. FCM or DCM) and the type of protocol used can be used to further select the desired modules. For example, a user may select an FCM generator for a VCR that uses AV/C protocol over 1394 as its private link. Similarly, the methods (functions) and code segments in a module can also be divided into groups and the methods (functions) and segments within a group follow a similar pattern respectively.As discussed further below, the above design of the target code 180 enables the use of code generators (252, 254, and 256 in FIG. 2) within the code generation engine 150 and templates 130 to encode the architecture of the target code 180. Preferably, the skeleton of a group of similar code modules is encapsulated in the module generators 254. A module generator 254 generates code modules 284. Client_Module_Generator and Server_Module_Generator are examples of module generators, and Java class modules are examples of code modules. The skeleton of a group of similar methods (functions) is encapsulated in the method generators 252. A method generator 252 generates methods 282. Client_Asyncronous_Method_Generator and Server_Operation_Method_Generator are examples of method generators. The skeleton of a group of similar code segments is encapsulated in the code segment generators 256. Examples of code segments are warning segments, include segments, error handling segments, and so on. Each template 210, 220 in FIG. 2 tags the differences. A code segment generator 256 resolves the differences and generates a sequence of consecutive statements 286. Argument_List_Generator and Include_Block_Generator are examples of segment generators.

The pattern of a group of statements and the pattern of a group of simple methods (functions) are encapsulated in templates 130. A template 130 comprises fixed portion and variable portion of a code segment according to a chosen programming language, such as “C”. The variable portion of a template is resolved at code generation time to turn the template 130 into a valid code segment of the code 180. A code segment generator typically contains one or more templates. Templates can be used to represent simple methods (functions), assuming that the code of the methods (functions) can be generated by resolving template variables.

In the following description, the term tree, sub-tree, node, leaf, parent, and child follow the standard definition used in computer science. Preferably, the code generation engine 150 is configured to generate code by traversing a tree of code generation nodes. Typically the root of the tree indicates all the modules to be generated for a standalone program, such as an FCM server program or an FCM client program. The children of the root are module generators for the code modules required by the program. A module generator node is the root of a sub-tree that generates the components of the module; the nodes in the sub-tree are method generators and code segment generators. Similarly, the node that represents a method generator is the root of the sub-tree that captures the structure of the method; the nodes in the sub-tree are other method generators and code segment generators. A leaf of a program tree comprises a code segment generator. To assure a termination of the code generation process, the root of a sub-tree does not appear as any node of the same sub-tree. For example, a module generator does not appear as a non-root node in its own sub-tree, and a method generator does not appear as an internal node of its own sub-tree.

As noted above, target code 180 is generated by code generators 252, 254, and 256. Every code generator has the knowledge of how to generate a particular portion of the target code 180, e.g. a module, a function, or a code segment. During a code generation process, a generator 252, 254, or 256 uses the user input, such as the type, model, and vendor of a device, to find information from the databases 120, 125, and 135 and uses the information to generate the portion of the code under its responsibility. When a generator encounters a template 130, it resolves the variable portion of the template 130 using the knowledge from the databases 120, 125, 135 and changes the template 130 into desired code. When a parent code generator encounters a child code generator while traversing a tree, the parent generator invokes the child generator to generate a corresponding portion of the code before continuing its own code generation. For example, when a module generator encounters a method generator, it invokes the method generator to generate the desired method. After the method is generated, the parent module generator resumes its work. Similarly, when a method generator encounters a child method generator or a child code segment generator, it invokes the child code generator, and resumes its own work only after the child generator finishes.

In a preferred embodiment of this invention, as illustrated in FIG. 1, a code cache 155 is provided to allow a user to save generated modules and methods (functions) for future code generation. The cache 155 contains pointers (such as file names) to the code and the conditions under which the code was generated. Such condition includes the version information of all the databases and user specification entered through the user interface. A typical scenario of using the code cache 155 is when a user modifies portion of the device specification 120, for example, adds a new feature, and desires to re-generate code. The code generation engine 150 in a preferred embodiment of this invention is configured to regenerate new code 180 only for the affected portions and use the code in the cache 155 for the unaffected portions.

The stack information database 125 of FIG. 1 contains the middleware stack implementation information needed for code generation. The database 125 also keeps track of the version of the stack implementation. A main portion of the information in the database 125 is the user-defined types declared in the stack, and file names that contain the declarations. This information is used to generate include files.

The template database 130 of FIG. 1 contains all the templates used by the code generation engine 150. A preferred embodiment of the database 130 saves each template as a file under a defined directory. The name of a template clearly indicates the place in the code generation where this template can be used. The database 130 also keeps track of the versions of templates.

The new code information database 140 of FIG. 1 contains the information about the code that has been generated by the code generation system. For example, it contains the user-defined types declared in the generated code, and the file names that contain the declarations. This information is used to generate include files.

The specification database 120 of FIG. 1 encodes the syntactic and semantic information in the middleware specification in the form that can be effectively used by the code generation engine 150 to generate the device-middleware integration code 180. The specification database 120 also retains version information. The version of the database 120 typically matches with the version of the corresponding middleware specification. However, if a user modifies the database 120 to support new features, the database 120 is provided an extension to its original version number. The version information is used to select the appropriate code from the code cache 155.

The database 120 provides the information required to generate portions of integration code 180 that are specific to a particular type of device. For example, in a HAVi embodiment, the database 120 includes the information required to generate integration code for Device Control Modules (DCM) and Function Control Modules (FCM).

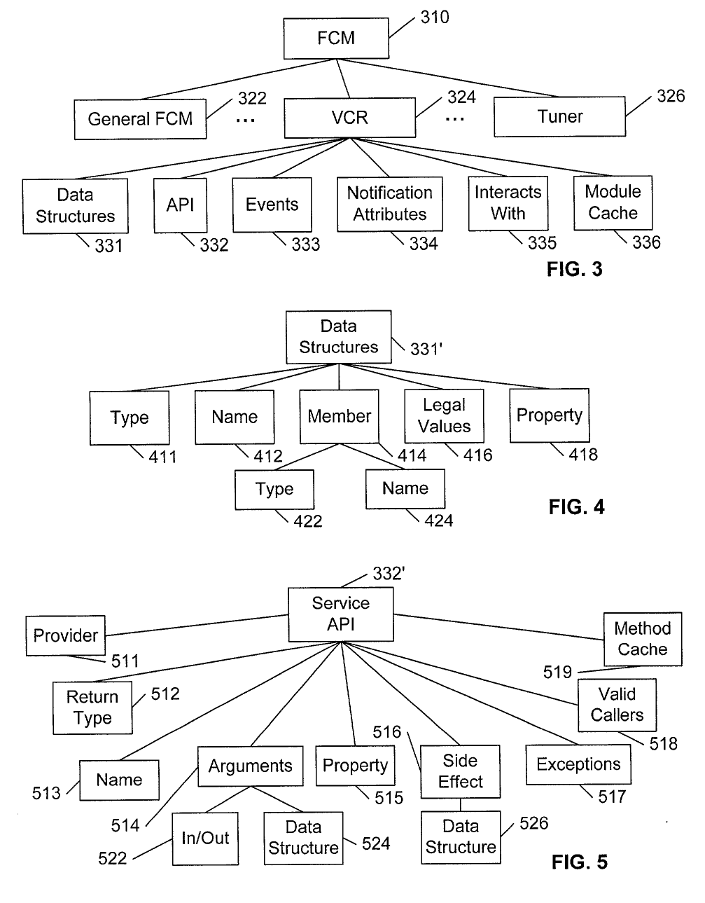

FIGS. 3 to 7 show examples of the information kept for each FCM type. In the examples, the information is organized as trees.

FIG. 3 illustrates an example block diagram of the top three levels of a Function Control Module (FCM) database 310 for use by a middleware code generation engine 150 in accordance with this invention. The second level includes a General FCM specification node 322, and specification information nodes that are indexed by an FCM type, such as VCR 324, tuner 326, and so on. The General FCM specification 322 contains information applicable to all FCMs, and the other specification applies only to a specific type of device. The third level shows the type of information kept by a parent node in the second level. For example, as shown in FIG. 3, for the VCR node 324, the third level includes Data Structures 331, Application Program Interfaces (API) 332, Events 333, and Notification Attributes 334 nodes. The third level also includes an Interacts With node 335 that records the HAVi managers (e.g. resource manager, stream manager, etc.) with which this FCM type 324 interacts. The Module Cache node 336 keeps track of the versions of module code 284 that have been saved by the user, and also records conditions under which the code module was generated, so that code that matches the required creation conditions can be retrieved. The conditions include the time of the latest user modification, and the versions of all the databases and templates used in generating the code.

In the case of HAVi, a DCM comprises one or more FCMs. In accordance with this invention, the structure under a root node DCM (not shown) is similar to that under FCM 310 of FIG. 3, except that the Notification Attributes node 334 is replaced by an FCM node (not shown). The FCM section keeps track of the Function Control Modules (such as recorder, player, tuner) contained in the Device Control Module (corresponding to the device that includes the particular functions).

FIG. 4 illustrates an example block diagram of a Data Structure entry 331′ in the Data Structures database 331 of FIG. 3, for use by a middleware code generation engine 150 of FIG. 1 in accordance with this invention. For ease of reference the prime symbol (′) is used after a reference numeral to indicate an example instance of a data item having the same reference numeral. The Data Structure 331′ records the data structures defined for a particular FCM type, e.g. VCR type. FIG. 4 illustrates the information 411-424 for each data structure that is used to generate include files and declaration statements that are specific to the FCM type, and to generate code 185 that checks the validity of the data. Each data structure 331′ has an associate data type 411 and identifying name 412. In a preferred embodiment, the data structure 331′ is also characterized as having particular properties 418, and, optionally, a predefined set of legal values 416. Each data structure 331′ includes one or more members 414, each member has a given type 422 and identifying name 424.

To enable the middleware to control an FCM, the FCM code exports services to the middleware. For example a VCR FCM exports services play, record, rewind, etc. to the middleware. An API is defined by the middleware specification to export every service, and the specification database 120 records this API for code generation purposes. FIG. 5 illustrates an example block diagram of a service API entry 332′ corresponding to the API block 332 of FIG. 3, for use by a middleware code generation engine 150 of FIG. 1 in accordance with this invention. FIG. 5 shows the example information 511-524 kept for each service API 332′. The information is used to generate methods (functions) related to the service in various modules. For example a VCR FCM module contains methods (functions) “play”, “record”, “rewind”, “forward”, and so on.

The Provider entry 511 indicates whether this service should be provided by a server or a client.

The Return Type entry 512 shows the data type of the item returned by the service (i.e. the method exporting the service) 332′.

The Name entry 513 records the name of the service 332′, e.g. play, record, or fast forward, etc.

The Arguments entry 514 records the parameters that should be passed to or returned from the service 332′. The In/Out entry 522 indicates whether the parameter is read only (input), write only (output), or read-write (both input and output), and the Data Structure entry 524 indicates the structure of each argument.

The Property entry 515 records information about the service, for example, whether the service needs to communicate to the physical device through the private link, and is used to generate interface code 180 (of FIG. 1) to the private link.

The Side Effects entry 516 indicates the data structures whose values change by the activation of the API 332′, if any. The Side Effects entry 516 also records the new value of each data structure after the change. Generally these data structures are a subset of the aforementioned Data Structures entries 331′ of the FCM 310 of FIG. 3. The Side Effect 516 information is used to generate notification code within the generated code 180.

The Exceptions entry 517 indicates the exceptions and error conditions relevant to this service. Although default code can be generated to handle exceptions and errors, the code generation system 100 in a preferred embodiment of this invention recommends the user to modify these code sections, as discussed above.

The Valid Callers entry 518 indicates the valid software element types that can invoke this API 332′, and is used to generate code 180 that requires checking of the callers' identity.

The Method Cache entry 519 keeps track of user saved methods (functions) for the service 332′. In addition to modification time and version information, the Method Cache entry 519 also records the module type to which a method (function) belongs.

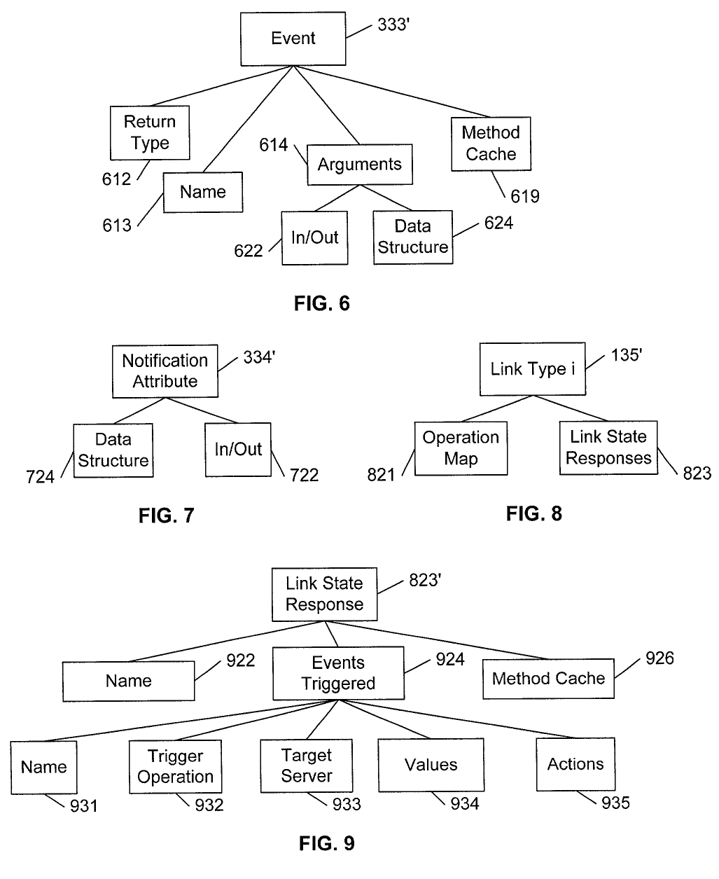

FIG. 6 illustrates an example block diagram of an Event 333′ in the Events entry 333 of FIG. 3, for use by a middleware code generation engine 150 of FIG. 1 in accordance with this invention. The Events entry 333′ records the events that an FCM type 310 of FIG. 3 should be involved. FIG. 6 illustrates the information kept for each event 333′. This information is used to generate event-related methods (functions) and code segments. The meaning of each node 612, 613, 614, 619, 622, 624 in FIG. 6 is the same as the meanings of each node 512, 513, 514, 519, 522, and 524 of FIG. 5.

FIG. 7 illustrates an example block diagram of a Notification Attribute 334′ in the Notification Attributes entry 334 of FIG. 3, for use by a middleware code generation engine 150 of FIG. 1 in accordance with this invention. The Notification Attributes 334′ records the attributes that trigger an FCM to post a notification when the attribute changes value. The Data Structure 724 and In/Out 722 entries define the attribute, as discussed above with regard to entries 524 and 522. The Notification Attribute information 334 is used to generate notification-related methods (functions) 282 and code 284 segments of FIG. 2.

FIG. 8 illustrates an example block diagram of a Private Link 135′ in the Private Link entry 135 of FIG. 1, for use by a middleware code generation engine 150 in accordance with this invention. The Private Link entry 135 records vendor-specific information that is relevant to code generation, and specifically, the information about each private link. FIG. 8 illustrates example information maintained for a link. The Operation Map 821 provides a correspondence between the name of an operation defined by the private link and the name defined by the middleware specification, and is used to generate code 180 that translates a command from the middleware to the corresponding operation to the physical device. The Link State Responses 823 records the names of the responses coming from the link, and is used to generate code 180 to handle the responses.

FIG. 9 illustrates an example block diagram of a Link State response 823′ of the Link State Responses entry 823 for use by a middleware code generation engine 150 in accordance with this invention, and illustrates the information kept for each link state response. The Name entry 922 is the name of the response, e.g. SUCCESS or NOT_IMPLEMENTED. The Events Triggered entry 924 indicates the events that should be part of the handling of the response. The information kept for each event 924 includes the event name 931, the triggering operation 932, the server from which the state data should be read 933, the action should be taken (read or post) 934, and the parameter values 935 if the event is to be posted. The Method Cache entry 926 keeps track of user saved methods (functions) for each Link State response 832′.

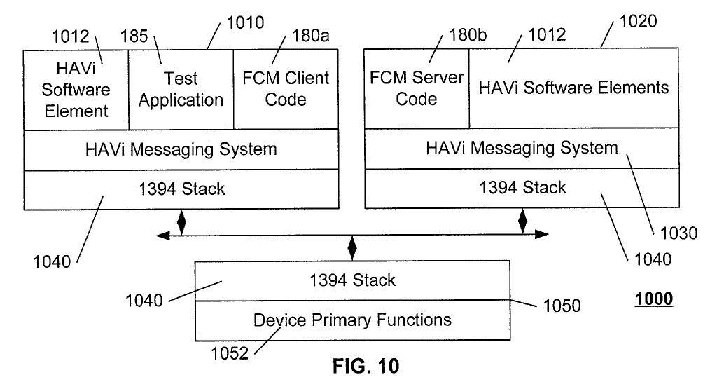

FIG. 10 illustrates an example block diagram 1000 of the installation of code 180, 185 that is generated in a middleware code generation system 100 in accordance with this invention, using a simplified view of HAVi as an example. A device 1050 is illustrated that is configured to allow control of its functions 1052 via an IEEE-1394 interface 1040 to two HAVi nodes 1010, 1020. A HAVi node 1010, 1020 is a software container that contains HAVi software elements 1012, the HAVi messaging system 1030, and a 1394 stack 1040. In this example, assume that the test application 185 is provided on the node 1010, and the device FCM is provided on the node 1020. The application 185 on the node 1010 in this example interacts with the FCM server code 180b on the node 1010 through the FCM client code 180a on the node 1010. The FCM client code, acting on behalf of the application 185, communicates with the FCM server code on 1020 through the HAVi messaging system and the 1394 stack. The FCM server 1020 thereafter interacts with the device 1050 under the control of the application 185.

The foregoing merely illustrates the principles of the invention. It will thus be appreciated that those skilled in the art will be able to devise various arrangements which, although not explicitly described or shown herein, embody the principles of the invention and are thus within the spirit and scope of the following claims.

I claim:

1. A program generation system, comprising:
a specification database that is configured to contain middleware information, based on a middleware specification,
a middleware code generation engine, operably coupled to the specification database, that is configured to produce middleware integration code, based on the middleware information.

2. The program generation system of claim 1, further including
a template database that is configured to contain one or more templates, and
wherein
the middleware code generation engine is further configured to produce the middleware integration code via an instantiation of the one or more templates, using data from the middleware information.

3. The program generation system of claim 1, further including
a private link database that is configured to contain link information that is specific to a particular link-type,
the link information including a mapping between link-operation names used by the particular link-type and middleware-operation names contained in the middleware information, and
wherein
the middleware code generation engine is further configured to produce the middleware integration code based on the link information.

4. The program generation system of claim 1, wherein
the middleware code generation engine is also configured to produce sample test application code, based on the middleware information.

5. The program generation system of claim 1, further including
a code cache, operably coupled to the middleware code generation engine, that is configured to store at least a portion of the middleware integration code for subsequent reuse.

6. The program generation system of claim 1, wherein
the middleware code generation engine is also configured to produce guideline information that facilitates a user modification of at least a portion of the middleware integration code.

7. The program generation system of claim 1, wherein
the middleware code generation engine includes at least one of:
a module generator that is configured to generate code modules,
a methods generator that is configured to generate methods code, and
a code segment generator that is configured to generate code statements.

8. The program generation system of claim 7, wherein
at least one of the methods generator and the code segment generator are configured to generate the methods code and the code statements based on a method template and a code segment template, respectively.

9. The program generation system of claim 1, wherein
the middleware information includes interfacing information for interfacing an application to one or more functions of a device that is controlled via a network corresponding to the middleware information.

10. The program generation system of claim 1, further including
a user interface system that includes tools that facilitate creating the specification database.

11. A method of program generation, comprising:
accessing a specification database that is configured to contain middleware information, based on a middleware specification,
generating middleware integration code, based on the middleware information.

12. The method of claim 11, further including
accessing a template database that is configured to contain one or more templates, and
wherein
generating the middleware integration code further includes instantiating the one or more templates, using data from the middleware information.

13. The method of claim 11, further including
accessing a private link database that is configured to contain link information that is specific to a particular link-type,
the link information including a mapping between link-operation names used by the particular link-type and middleware-operation names contained in the middleware information, and
wherein
generating the middleware integration code further includes generating the middleware integration code based on the link information.

14. The method of claim 11, further including
generating sample test application code, based on the middleware information.

15. The method of claim 11, further including
storing at least a portion of the middleware integration code for subsequent reuse.

16. The method of claim 11, further including
providing guideline information that facilitates a user modification of at least a portion of the middleware integration code.

17. The method of claim 11, wherein
generating the middleware integration code includes:
generating code modules,
generating methods code, and
generating code statements.

18. The method of claim 17, wherein
generating at least one of the methods code and the code statements includes accessing a corresponding method template and code segment template, respectively.

19. The method of claim 11, further including
providing interfacing information for interfacing an application to one or more functions of a device that is controlled via a network corresponding to the middleware information.

20. The method of claim 11, further including
providing tools that facilitate creating the specification database.
